(19) United States
(12) Patent Application Publication
(10) Pub. No.: US 2004/0220867 A1
(43) Pub. Date: Nov. 4, 2004

(54) Asset to property conversion process

(76) Inventors: Daniel Ray Messick, Lisle, IL (US); Christine Miller Mount, Schaumburg, IL (US)

Correspondence Address: CANON U.S.A. INC. INTELLECTUAL PROPERTY DEPARTMENT, 15975 ALTON PARKWAY, IRVINE, CA, 92618-3731, US

(21) Appl. No.: 10/427,292

(22) Filed: May 1, 2003

(51) Int. Cl. G06F 17/60

(52) U.S. Cl. 705/36

(57) ABSTRACT

A method for controlling and managing assets of all kinds by providing a single process to facilitate acquisition, control, development, declaration, and protection throughout the lifecycle of the asset. The process comprises acquiring an asset, gaining control and an understanding of the asset, developing the asset by enhancing its value, obtaining rights in the asset, and managing the asset as a property. In addition, data resulting from each of these is aggregated through cumulative assimilation into a single metadata record.

### BACKGROUND OF THE INVENTION

1. Field of the Invention

The present invention relates generally to controlling and managing assets, and more particularly to controlling and managing assets of all kinds by providing a single process to facilitate acquisition, control, development, declaration, and protection throughout the lifecycle of the asset(s).

2. Description of the Related Art

Traditionally, intellectual property (IP) assets have been managed through methods that rely on paper as a medium for control. IP assets include items such as patents, copyrights, trademarks, service marks, and trade secrets. The act of recording the expression of the intellectual property to paper has been, in itself, a control mechanism and an asset management method. Historically, these processes operate under the assumption that the intellectual property is embodied as print on paper.

Print on paper then, has acted as a primary control mechanism and serves a key purpose in facilitating traditional processes for handling, claiming, and controlling intangible assets such as intellectual property. Paper acts as the medium for exchange of intellectual property when it is handled and where claims to ownership and title are made. Paper acts as a method of transport and delivery when intellectual property is transferred to the user at the point of consumption. Publishing, specifically books, serve as an effective example. When a book is printed, distributed, and sold to the consumer, it is the tangible paper that actually changes hands. The intangible asset, or intellectual property, is transferred from buyer to seller as a result of the process of moving paper.

When paper as the medium of transfer is removed, the fundamental basis for much of the intellectual asset management process is removed as well. The consequences of this circumstance is most evident in the case of electronic business applications where the commodity being exchanged is intellectual property commonly known as “content” and the methods for distribution and delivery are all electronic as in the case of a computerized system for passing information from source to consumer through a network of web sites like the Internet.

The proliferation of electronic computer technology and the Internet as a primary, non-paper based vehicle for the transfer of intellectual property on a scale that is significantly greater than traditional paper based systems of exchange and process control, has generated a significant need in the environment for standard processes to manage and control common intellectual property.

Current asset management approaches are separated into two distinct classifications: content management and digital rights management. Typically, in a single organization, the entity in charge of the content management is not the same as the entity in charge of the digital rights management. And, typically, the communication between the two entities is somewhat unclear, resulting in a fractured approach of controlling and managing the asset.

What is needed is a process that, when applied to all forms of assets, provides a mechanism for control and management of an asset, regardless of the form it may take, the state it is in, the application or use, the ownership or title, the value assigned, or the environment in which is resides. In addition, what is needed is a single process to facilitate control and management throughout the asset's lifecycle.

### SUMMARY OF THE INVENTION

It is an object of the foregoing invention to address the foregoing difficulty by providing a method for controlling and managing assets of all kinds by providing a single process to facilitate acquisition, control, development, declaration, and protection throughout the lifecycle of the asset. This process results in the ability to construct and retain records of appraised financial values for portfolio management purposes, improve efficiencies in the use and application of individual assets, groups of assets and both tangible and intangible asset property portfolios, the ability to improve efficiencies in the acquisition, divestiture, accumulation, integration, and disintegration and commingling of both tangible and intangible asset property portfolios, the ability to improve access to information essential for the measurement and valuation of intangibles, and the ability to position the portfolio of assets as a potential commodity for trading in future intellectual property exchanges.

Thus one aspect of the present invention is a process for managing assets comprising acquiring an asset, gaining control and an understanding of the asset, developing the asset by enhancing its value, obtaining rights in the asset, and managing the asset as property.

In yet another aspect, data resulting from each domain of the process is aggregated through cumulative assimilation into a single metadata record.

This brief summary has been provided so that the nature of the invention may be understood quickly. A more complete understanding of the invention can be obtained by reference to the following detailed description of the preferred embodiment(s) thereof in connection with the attached drawings.

### BRIEF DESCRIPTION OF THE DRAWINGS

FIG. 1 is a representational view depicting a general configuration of the system in which the process of the present invention is implemented.

FIG. 2 is a block diagram illustrating the internal architecture of a computer implementing the asset management application of the present invention.

FIG. 3 is a block diagram describing the preferred embodiment of the process for controlling and maintaining assets of the present invention.

FIG. 4 is a block diagram describing the preferred embodiment for a domain in the process for controlling and maintaining assets of the present invention.

FIG. 5 is a block diagram describing the preferred embodiment for another domain in the process for controlling and maintaining assets of the present invention.

FIG. 6 is a block diagram describing the preferred embodiment for another domain in the process for controlling and maintaining assets of the present invention.

FIG. 7 is a block diagram describing the preferred embodiment for another domain in the process for controlling and maintaining assets of the present invention.

FIG. 8 is a block diagram describing the preferred embodiment for another domain in the process for controlling and maintaining assets of the present invention.

### DETAILED DESCRIPTION OF THE PREFERRED EMBODIMENTS

The preferred embodiment of the present invention is implemented in an organizational environment, i.e., a company. However, the application of the present invention is not limited to this type of environment.

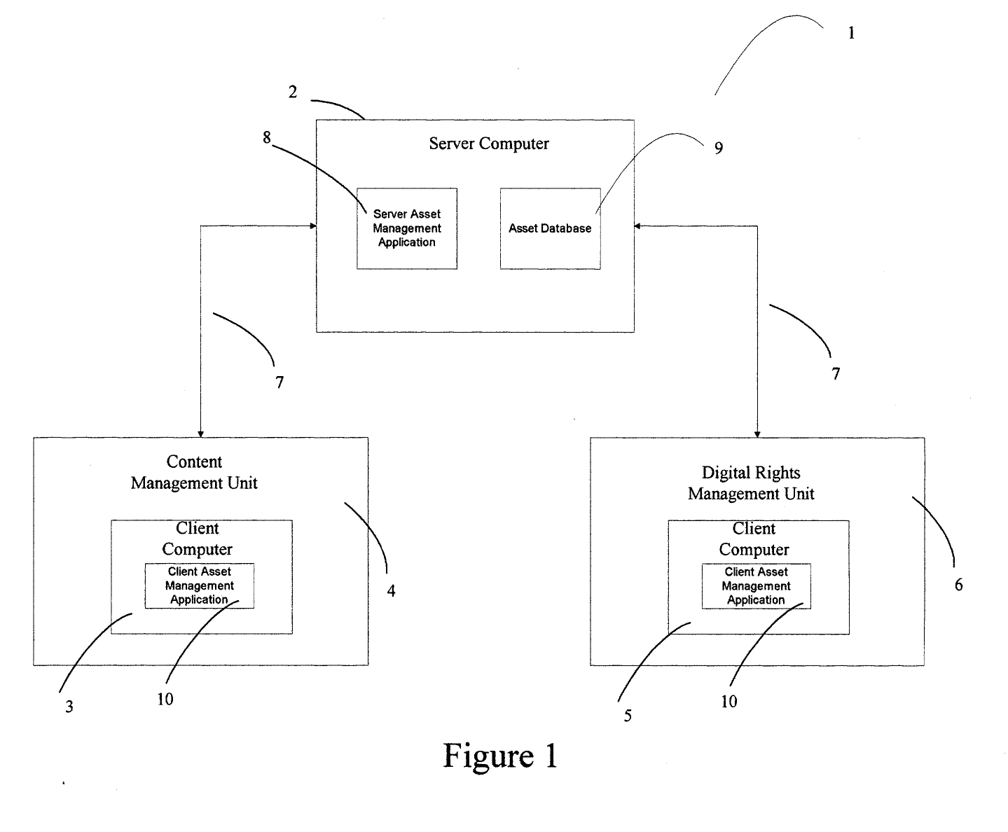

FIG. 1 is a representational view depicting a general configuration of the system in which the process of the present invention is implemented. The process of the present invention is not limited to being implemented via the system depicted in FIG. 1 and any system or platform enabling practice of the invention is applicable. Asset management system 1 includes server computer 2, client computer 3 residing in an organization's Control Management Unit 4, and client computer 5 residing in an organization's Digital Rights Management Unit 6. Client computers 3, 5 are connected to server computer 2 via a network interface 7.

Server computer 2 contains server asset management application 8 and asset database 9, wherein server asset management application 8 implements the process of the present invention. Client computers 3, 5 contain client asset management application 10, wherein client asset management application implements the process of the present invention.

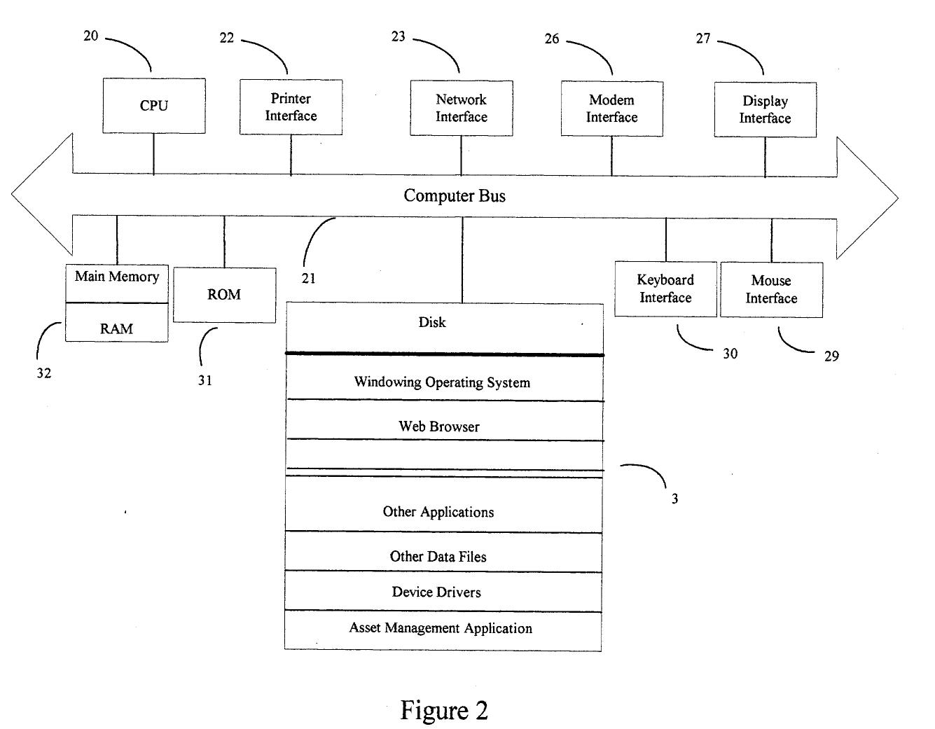

FIG. 2 is a block diagram of the internal architecture of client computer 3 and 5. Shown in FIG. 2 is CPU 20, which is preferably a Pentium-type microprocessor, interface to computer bus 21. Also interface to computer bus 21 are printer interface 22, to allow client computer 3, 5 to communicate with a local printer (not shown), network interface 23 to enable communications between client computer 3, 5 and a network, modem interface 26 to enable communications between client computer 3, 5 and its internal modem (not shown), display interface 27 for interfacing with a display monitor (not shown), keyboard interface 30 for interfacing with a keyboard (not shown), and mouse interface 29 for interfacing with a mouse (not shown). Of course, if client computer 3, 5 connect to the World Wide Web 12 by a connection other than a telephone connection, a suitable interface other than modem interface 26 may be utilized.

Read only memory (ROM) 31 stores invariant computer-executable process steps for basic system functions such as basic I/O, start-up, or reception of keystrokes from a keyboard. Main random access memory (RAM) 32 provides CPU 20 with memory storage that can be accessed quickly. In this regard, computer-executable process steps of the client asset management application of the present invention or other applications are transferred from disk 3 over computer bus 21 to RAM 32 and executed therefrom by CPU 20.

Also shown in FIG. 2 is disk 3, which, in addition to the application of the present invention, includes a windowing operating system, a web browser executable on the particular windowing operating system, other applications which may include word processing, spreadsheet, graphics, and gaming applications. Disk 3 further includes data files and device drivers as shown.

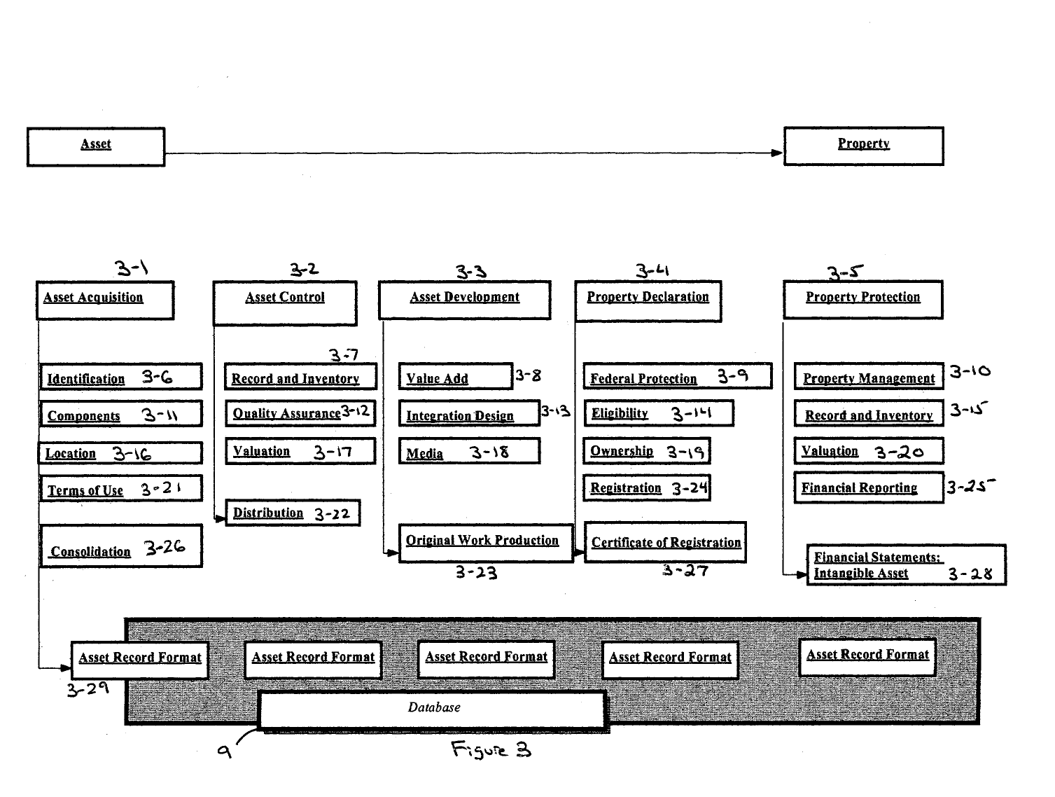

FIG. 3 is a block diagram describing the preferred embodiment of the process for controlling and managing assets of the present invention. Briefly, the process of the present invention facilitates acquisition, control, development, declaration, and protection of an asset through the asset's lifecycle from an asset to property, while building a cumulative record of the results from each of these domains. The acquisition, control, and development domains of the process are directed towards control management of an asset, while the declaration and protection domains of the process are directed towards dealing with the asset as a property right. The present invention is not limited to a specific number of domains and any combination of domains that would allow practice of the present invention would be applicable.

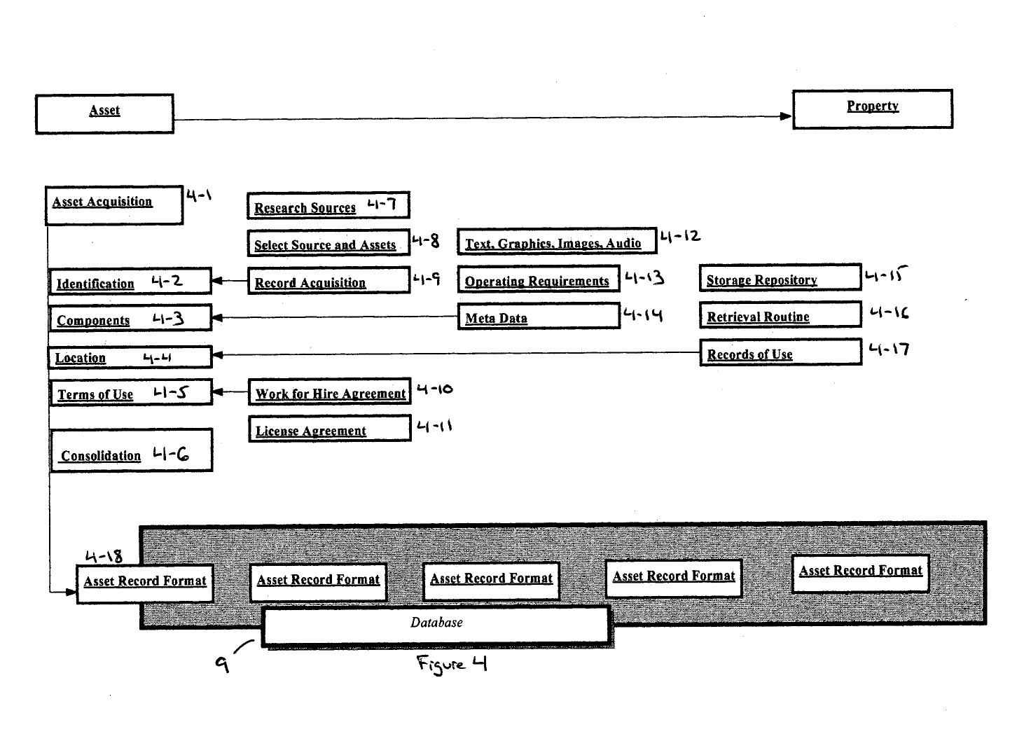

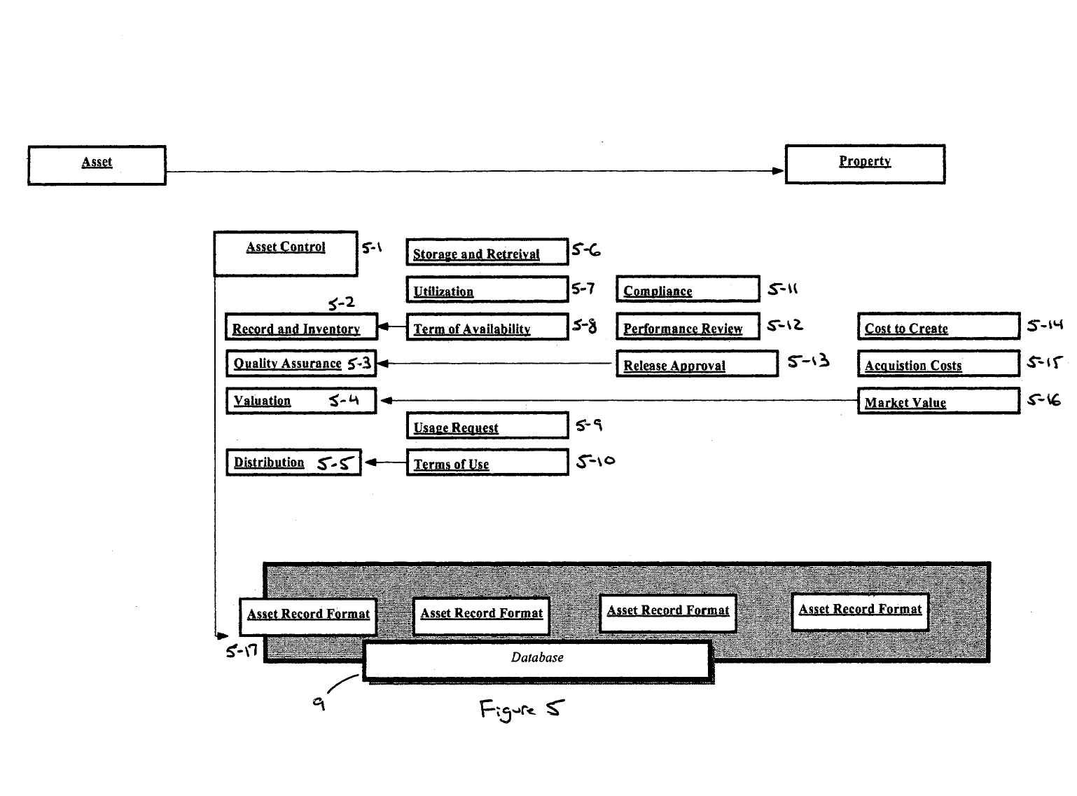

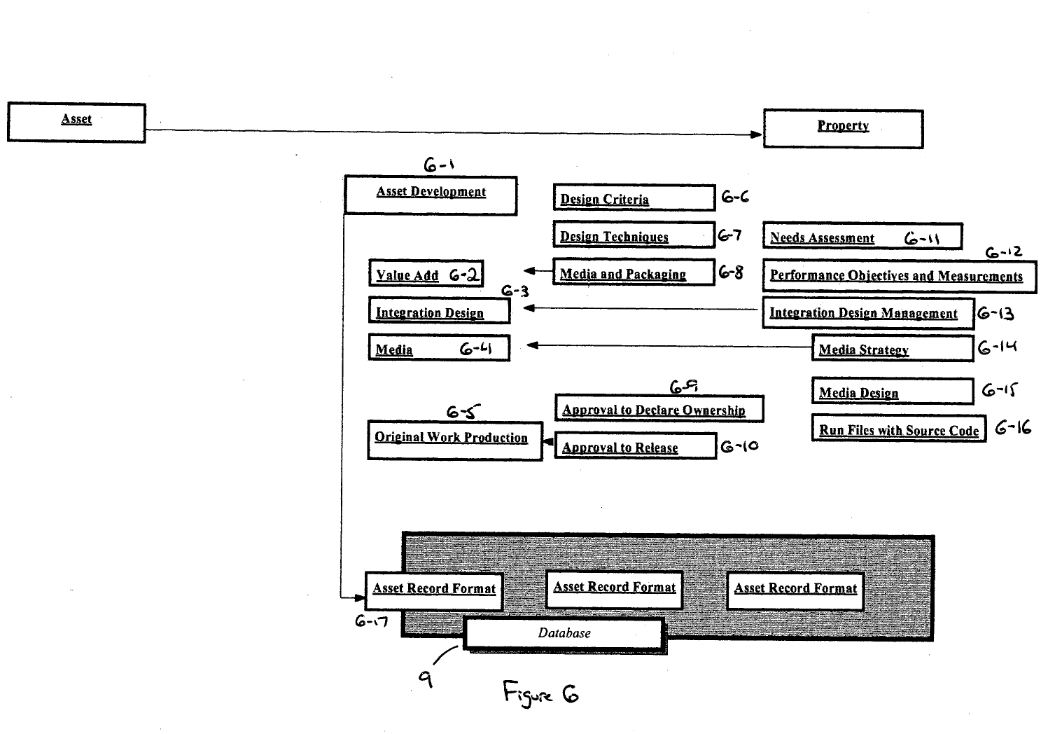

In more detail, an asset is acquired in Asset Acquisition 3-1. Acquiring of an asset includes the Identification 3-6, Components 3-11, Location 3-16, Terms of Use 3-21, and Consolidation 3-26. These elements are described below in more detail in reference to FIG. 4. Once an asset has been acquired, it is controlled in Asset Control 3-2. Control of an asset consists of Record and Inventory 3-7, Quality Assurance 3-12, Valuation 3-17, and Distribution 3-22. These elements are described in detail below in the FIG. 5 discussion. After an asset is acquired and controlled, it is developed in Asset Development 3-3. Asset Development 3-3 comprises Value Add 3-8, Integration Design 3-13, Media 3-18, and Original Work Production 3-23. FIG. 6 describes each of these elements in more detail.

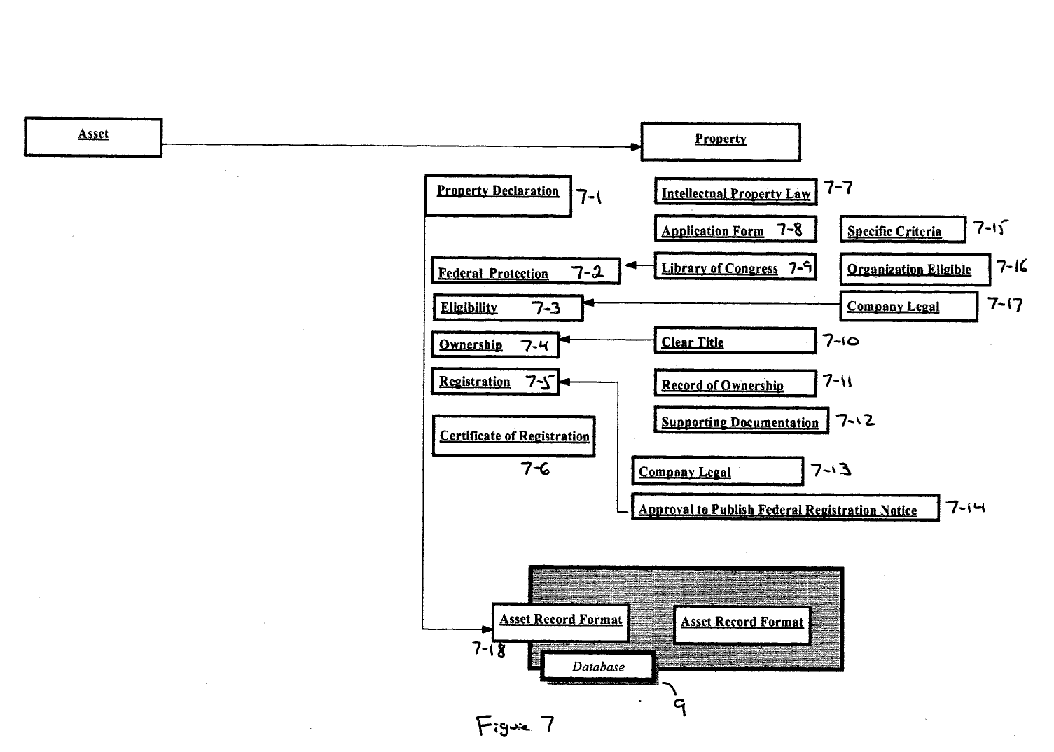

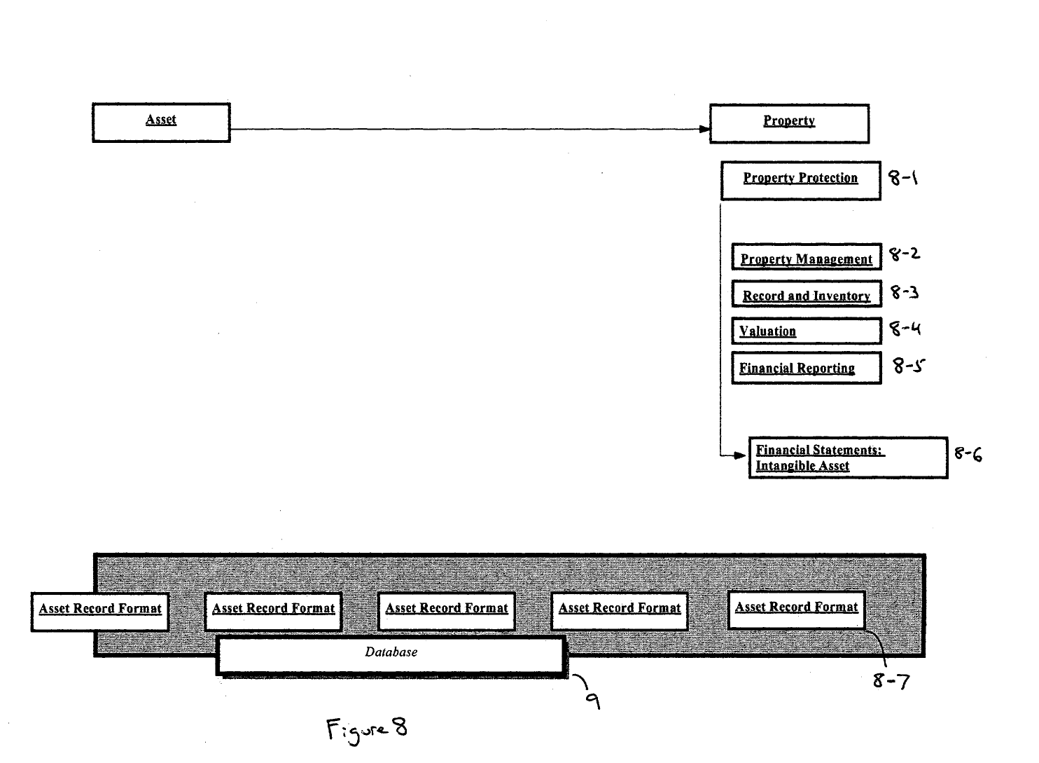

After an asset has been acquired, controlled, and developed, it is treated as property. In Property Declaration 3-4, the rights in the property are established. Property Declaration 3-4 consists of Federal Protection 3-9, Eligibility 3-14, Ownership 3-19, Registration 3-24, and Certification of Registration 3-27. A more detailed description of these elements is provided below in the discussion of FIG. 7. Once rights in the property have been established, the next domain is Property Protection 3-5. Property Protection 3-5 entails Property Management 3-10, Record and Inventory 3-15, Valuation 3-20, Financial Reporting 3-25, and Financial Statements 3-28. Property Protection 3-5 is described in more detail below with respect to FIG. 8.

FIG. 4 is a block diagram describing the preferred embodiment for a domain in the process for controlling and maintaining assets of the present invention. However, the present invention is not limited to the number of elements depicted in FIG. 4 and described below and any combination of elements that would allow practice of the present invention would be applicable. Briefly, Asset Acquisition 4-1 defines the process of acquiring an asset.

In more detail, Identification 4-2 comprises Research Sources 4-7, Select Source and Assets 4-8, and Record Acquisition 4-9. Research Sources 4-7 includes searching sources of potential assets. For example, in an organization, sources of assets include internal employees as well as outside contractors. After locating sources for potential assets, specific assets and their associated sources are selected in Select Source and Assets 4-8. This selection element consists of several criteria used to determine whether the asset in question is of interest to the organization. One criterion, for example, could be the potential value of the asset to the organization. The criteria are organization specific. Once an asset and its source have been selected, the data associated with acquisition of the asset is recorded in Record Acquisition 4-9. Included in this data is information on when the asset was acquired along with the source of the asset. The information is recorded in a metadata file that is associated with the asset.

After identification of an asset in Identification 4-2, the components of the asset, the environment in which the asset can be operated on, and any data associated with the asset are identified in Components 4-3. Text, Graphics, Images, Audio 4-12 documents the type and format of the asset. The type and format of an asset can be, but is not limited to, text, graphics, illustrations, images, audio, etc. Based on the type and format of an asset, in Operating Requirements 4-13, the environment in which the asset can be operated on is determined. For example, if the asset is a JPEG formatted image file, any modifications (i.e., color enhancement, cropping, etc.) that may need to be done to the file can be accomplished in any digital image editing software application that supports JPEG formatted files. Therefore, Operating Requirements 4-13 would reflect that the operating environment associated with the image file is a digital image editing software application. Finally, if the asset has an associated metadata file, then the information contained in that file, such as the file's format, type, data of creation, etc., is obtained in Metadata 4-14.

The next element in Asset Acquisition 4-1 is Location 4-4, where location information for the asset is established. Storage Repository 4-15 defines the storage location for the asset. For example, asset database 9 on server computer 2. Next, Retrieval Routine 4-16 defines the process that will be used to locate and retrieve the asset from its storage location. Preferably, a standard process is implemented so that all assets are located and retrieved in the same manner. For example, all assets of a similar type (i.e., digital images) will be named using a particular nomenclature per an established standard. This ensures that all assets can be easily located and retrieved. Records of Use 4-17 identifies what asset retrieval records will be tracked. Such records include, but are not limited to, which individuals retrieved the asset, when the retrieval took place, and why the asset was retrieved

After Location 4-4, the terms under which the asset can be used are established in Terms of Use 4-5. Sources for this information includes Work for Hire Agreement 4-10 and License Agreement 4-11. Work for Hire Agreement 4-10 contains use restrictions associated with an asset acquired as a result of a work-for-hire agreement. License Agreement 4-11 contains use restrictions associated with an asset acquired via a license agreement. These two cases are applicable where the source of the asset is external third party to the organization. In the case where the source of the asset is internal to the organization, i.e., an employee of the organization, this element would not be applicable.

Upon the completion of Identification 4-2, Components 4-3, Location 4-4, and Terms of Use 4-5, in Consolidation 4-6, the data obtained and/or established by each of these elements is aggregated into a single metadata file Asset Record Format 4-18. In the preferred embodiment, metadata resulting from the remaining domains and their associated elements of the process of the present invention are aggregated into Asset Record Format 4-18 as each element of each domain in the process is completed. Thus, at the end of the process, Asset Record Format 4-18 is a cumulative assimilation of all the data for a particular asset. In another embodiment, metadata is aggregated into Asset Record Format at the completion of each domain of the process instead of at the completion of each element of each domain. Preferably, Asset Record Format 4-18 is stored in database 9. However, any storage location enabling practice of the present invention is applicable.

FIG. 5 is a block diagram describing the preferred embodiment for another domain in the process for controlling and maintaining assets of the present invention. However, the present invention is not limited to the number of elements depicted in FIG. 5 and described below and any combination of elements that would allow practice of the present invention would be applicable. Briefly, Asset Control 5-1 defines the process for gaining control and an understanding of the asset acquired in Asset Acquisition 4-1.

More specifically, Record and Inventory 5-2 provides an inventory of acquired assets, as well as usage information relating to a particular asset. In Storage and Retrieval 5-6, the process established in Retrieval Routine 4-16 is applied to a particular asset to locate and retrieve the asset. This is done to verify the accuracy of the asset's location established in Storage Repository 4-15 and the location and retrieval process implemented in Retrieval Routine 4-16. This check is important so as to ensure that the asset's location is consistent and the process for locating and retrieving the asset is viable.

Utilization 5-7 addresses the function of tracking the rate or frequency with which a particular asset has been retrieved. This provides an indication for how often a particular asset is used, since an asset will typically not be retrieved unless it is going to be used. Term of Availability 5-8 provides information as to how long the asset can be retrieved or accessed. Typically, for externally acquired assets, the terms under which the asset was acquired dictate the length of time the asset can be used. For internally acquired assets, this information is typically not applicable. Preferably, once the term of availability of the asset has expired, retrieval or access is no longer allowed. All of the above information is then incorporated into Asset Record Format 5-17, which was carried forward from Asset Acquisition 4-1.

Next, in Quality Assurance 5-3, the asset is subjected to several quality assurance reviews before access to it is allowed. Compliance 5-11 verifies that the asset complies with established organizational standards of use. For example, many organizations do not want to associate themselves with something that would put the organization in a bad light in the eyes of their shareholders or the public. In order to avoid associating themselves with such things, organizations have created criteria that an item must meet in order for the organization to associate itself with it. In this case, the item is the asset.

In addition to meeting the above standards of use test, in Performance Review 5-12, the asset is reviewed, based on a set of criteria, to ensure the asset can be used. For example, a check is made to confirm that the application needed to support the asset is identified. In other words, if the asset type as obtained in Components 4-3 is a digital image, then Performance Review 5-12 ensures a digital image viewing/editing software application is identified so that asset can be used. If the asset meets the criteria of Compliance 5-11 and Performance Review 5-12, then in Release Approval 5-13, access to the asset is allowed. All of the information relating to Quality Assurance 5-3 is then incorporated into Asset Record Format 5-17.

Following Quality Assurance 5-3 is Valuation 54. Valuation 54 is where a monetary value is associated with the asset. This value is obtained by taking into consideration among other things, the cost associated with creating the asset 5-14, the cost associated with acquiring the asset 5-15, and the market value 5-16 of the asset. All of this information is in turn incorporated into Asset Record Format 5-17.

Yet another element in Asset Control 5-1 is Distribution 5-5. Distribution 5-5 controls the distribution of the asset based on how the asset can be used. Upon receipt of a usage request 5-9, a determination is made whether the usage request is consistent with the terms under which the asset can be used 5-10. If the usage request falls within the terms of use, then the asset is distributed to the requestor. If the usage request is outside the scope of use, the asset will not be distributed. Distribution 5-5 information is then incorporated into Asset Record Format 5-17.

FIG. 6 is a block diagram describing the preferred embodiment for another domain in the process for controlling and maintaining assets of the present invention. However, the present invention is not limited to the number of elements depicted in FIG. 6 and described below and any combination of elements that would allow practice of the present invention would be applicable. Briefly, Asset Development 6-1 defines the process for developing of the asset acquired in Asset Acquisition 4-1 and controlled in Asset Control 5-1 by enhancing the value of the asset.

More specifically, Value Add 6-2 is the process for adding non-monetary value to the asset. Design Criteria 6-6 establishes, among other things, what can be done to add value, how the value can be added, and what the desired added value is. Design Techniques 6-7 establishes the process to apply to the asset to reach the desired value. Media and Packaging 6-8 determines in what media and/or packaging the asset will be produced, or what the most appropriate media/packaging is for the asset. All of this information is then incorporated into Asset Record Format 6-17, which is carried forward from Asset Control 5-1. To better understand how these elements function to add value to an asset, the following example is provided.

The asset in this example is a manuscript. A determination is made that value can be added to the manuscript by supplementing it with/adding to it an illustration. In this case, the desired value is enhancement of the manuscript by the addition of an illustration. The process for reaching this desired value is to add the illustration to the manuscript. Once the illustration has been added, the enhanced manuscript can either be produced as a hard copy or as an electronic copy. The determination whether to produce a hard copy or an electronic copy can be based on, among other things, the intended audience of the manuscript.

In some instances, the determination as to what media and/or packaging should be used to produce the asset will impact the process used to apply the asset to reach the desired value. For example, the process of adding an illustration to a manuscript will be different if a hard copy of the manuscript is published versus if the manuscript is published on an Internet web page.

Another element of Asset Development 6-1 is Integration Design 6-3. Integration Design 6-3 is applicable where two or more separate assets are combined to meet a particular need. For example, in the case where an illustrated manuscript is needed but no such manuscript exists, an illustration can be integrated into or combined with a manuscript to achieve the desired result. In this case, the illustration and manuscript are controlled as separate individual assets. One aspect of Integration Design 6-3 is Needs Assessment 6-11, where a particular need to integrate separate assets is established. In Performance Objectives and Measurements 6-12, the objectives to meet the need established in Needs Assessment 6-11 are generated. Along with the objective, the measurements used to determine whether the objectives have been met are also generated.

After the needs, the objectives required to meet the needs, and the measurements with which to verify the objectives meet the needs have been established, Integration Design Management 6-13 verifies whether integration of the separate assets meets the established objectives. Information associated with Integration Design 6-3 is then incorporated into Asset Record Format 6-17.

Still yet another element of Asset Development 6-1 is Media 6-4. Media 6-4 deals with how the overall approach of applying the media determined to be most applicable for the asset in Media and Packaging 6-8. Media Strategy 6-14 determines the strategy of how to apply or deal with selected media. Media Design 6-15 defines the design of the media chosen to implement the asset. For example, if the media is a hard copy, Design 6-15 defines such items as location of page number, location of titles, location of logos, etc. In Run Files with Source Code 6-16, the elements of Media Strategy 6-14 and Media Design 6-15 are applied to the asset to ensure that that the end result is what was expected. The above information is then incorporated into Asset Record Format 6-17.

Upon completion of Asset Acquisition 4-1, Asset Control 5-1, and the above described elements of Asset Development 6-1, a decision is made in Approval to Declare Ownership 6-9 whether to continue onto the next domain, Property Declaration 7-1, of the process of the present invention. In Approval to Declare Ownership 6-9, the process of the present invention changes from one of content management to one of digital rights management.

If the decision in Approval to Declare Ownership 6-9 is to continue onto the next domain of the process of the present invention, then in Approval to Release 6-10, approval to release the asset for use is provided. The decision whether to continue or not is based on the various factors obtained or established in Asset Acquisition 4-1, Asset Control 5-1, and the previous elements of Asset Development 6-1. Upon receipt of approval to release the asset, in Original Work Production 6-5, an original work or master of the asset is produced. For example, an original master hardcopy of a manuscript is generated. The approval information is incorporated into Asset Record Format 6-17 regardless of whether approval was provided or not provided.

FIG. 7 is a block diagram describing the preferred embodiment for another domain in the process for controlling and managing assets of the present invention. However, the present invention is not limited to the number of elements depicted in FIG. 7 and described below and any combination of elements that would allow practice of the present invention would be applicable. Briefly, Property Declaration 7-1 defines the process for obtaining rights in the asset.

In Federal Protection 7-2, an analysis is performed to determine whether there is a legal basis for obtaining rights in the asset. This is accomplished by reviewing the applicable requirements for obtaining a particular right in Intellectual Property Law 7-7. For example, if the right being sought is a United States patent, United States patent laws would be analyzed to ensure the asset met the requirements for obtaining a United States patent. A potential source for the requirements could be the Library of Congress 7-9. In Application Form 7-8, the necessary paperwork to file an application is obtained. The information associated with Federal Protection is incorporated into Asset Record Format 7-18, which has been carried forward from Asset Development 6-1.

Next, in Eligibility 7-3, the organization performs an analysis to determine whether it makes sense for the organization to continue seeking rights in the asset. The determination is based on a set of criteria (Specific Criteria 7-15) that is organization specific. For example, in determining whether to file a patent, the cost of filing is weighed against the potential value of the patent. If the criteria set forth in Specific Criteria 7-15 is met, then in Organization Eligible 7-16 a decision is made to proceed with seeking the rights in the asset, and legal assistance in seeking the asset is obtained in Company Legal 7-17. Eligibility 7-3 information is then incorporated into Asset Record Format 7-18.

In Ownership 7-4, a final check is performed to confirm ownership of the asset prior to filing the necessary paperwork to obtain rights in the asset (Clear Tide 7-10). This information is incorporated into Asset Record Format 7-18.

In Registration 7-5, the paperwork to obtain rights in the asset is filed. For example, if the right sought is a United States patent, a patent application is filed with the United States Patent and Trademark Office. Filing of the paperwork is typically done via a legal representative (Company Legal 7-13). In addition, once official notification that the right in the asset has been obtained (i.e., notice of allowance of patent application from United States Patent and Trademark Office), approval is provided to publicize that a right in the asset has been obtained (Approval to Publish Federal Registration Notice 7-14). Formal paperwork associated with the right is also obtained and tracked (Certificate of Registration 7-6). Registration 7-5 information is incorporated into Asset Record Format 7-18 as it becomes available.

FIG. 8 is a block diagram describing the preferred embodiment for another domain in the process for controlling and managing assets of the present invention. However, the present invention is not limited to the number of elements depicted in FIG. 8 and described below and any combination of elements that would allow practice of the present invention would be applicable. Briefly, Property Protection 8-1 defines the process for managing the asset as a property.

In more detail, Property Management 8-2 deals with the various aspects of managing the asset as a property. This includes enforcing the rights associated with the property obtained in Property Declaration 7-1. Record and Inventory 8-3 provides an inventory of rights as well as usage information relating to a particular property. Valuation 84 tracks the value of the property. For example, if several licenses are issued for a particular property, the value of the property increases each time a license is issued. The value obtained in Valuation 84 is incorporated into the organization's financial reporting information in Financial Reporting 8-5. Finally, in Financial Statements: Intangible Asset 8-6 the financial value associated with the property is included the organization's financial statements. All of this information is in turn incorporated into Asset Record Format 8-7, which is carried forward from Property Declaration 7-1.

The process of the present invention results in an ability to implement sophisticated asset management techniques, including best practices, standard procedures, and advanced technology with each of the above described domains, while building a cumulative record of the results from each domain. An improved relationship between handling, legal titling, and financial appraisal of an asset is achieved, as well as an improvement in control over cost structures involved in managing an asset.

While the invention is described above with respect to what is currently its preferred embodiment, it is to be understood that the invention is not limited to that described above. To the contrary, the invention is intended to cover various modifications and equivalent arrangements within the spirit and scope of the appended claims.

What is claimed is:

1. A process for managing assets comprising the steps of:
acquiring information regarding the at least one asset;
gaining control of the acquired asset;
enhancing the value of the acquired asset;
obtaining rights in the acquired asset; and
managing the rights obtained in the acquired asset.

2. A process according to claim 1, wherein the acquiring step comprises:
identifying the source of the asset;
identifying the components of the asset;
determining the storage location of the asset; and
identifying usage information associated with the asset.

3. A process according to claim 1, wherein the controlling step includes:
inventorying the asset;
verifying the asset meets a quality standard;
assigning a monetary value to the asset; and
making the asset available for use.

4. A process according to claim 1, wherein the enhancing step includes:
assigning a non-monetary value to the asset;
defining a need for the asset;
defining a method to determine if the asset meets the need;
determining a media to use to produce the asset based on the need;
confirming ownership of the asset;
creating a product from the asset.

5. A process according to claim 1, wherein the managing step includes:
enforcing the rights obtained in the asset; and
assessing value to the asset.

6. A process according to claim 1, wherein data acquired from the steps of claim 1 is aggregated into a single metadata file associated with the asset.

7. A system for managing assets comprising:
computer-readable program code means for acquiring information regarding the at least one asset;
computer-readable program code means for gaining control of the acquired asset;
computer-readable program code means for enhancing the value of the acquired asset;
computer-readable program code means for obtaining rights in the acquired asset; and
computer-readable program code means for managing the rights obtained in the acquired asset.

8. A system according to claim 7, wherein the computer-readable program means code for acquiring information includes:
identifying the source of the asset;
identifying the components of the asset;
determining the storage location of the asset; and
identifying usage information associated with the asset.

9. A system according to claim 7, wherein the computer-readable program code means for gaining control includes:
inventorying the asset;
verifying the asset meets a quality standard;
assigning a monetary value to the asset; and
making the asset available for use.

10. A system according to claim 7, wherein the computer-readable program code means for enhancing the value includes:
assigning a non-monetary value to the asset;
defining a need for the asset;
defining a method to determine if the asset meets the need;
determining a media to use to produce the asset based on the need;
confirming ownership of the asset;
creating a product from the asset.

11. A system according to claim 7, wherein the computer-readable program code means for managing includes:
enforcing the rights obtained in the asset; and
assessing value to the asset.

12. A system according to claim 7, wherein data acquired by the computer-readable program code means of claim 7 is aggregated into a single metadata file associated with the asset.

13. A computer-readable memory medium storing computer-executable process steps for managing assets comprising:
an acquiring step to acquire information regarding the at least one asset;
a controlling step to gain control of the acquired asset;
an enhancing step to enhance the value of the acquired asset;
an obtaining step to obtain rights in the acquired asset; and
a managing step to manage the rights obtained in the acquired asset.

14. A computer-readable memory medium storing computer-executable process steps according to claim 13, wherein the acquiring step includes:
identifying the source of the asset;
identifying the components of the asset;
determining the storage location of the asset; and
identifying usage information associated with the asset.

15. A computer-readable memory medium storing computer-executable process steps according to claim 13, wherein the controlling step includes:
inventorying the asset;
verifying the asset meets a quality standard;
assigning a monetary value to the asset; and
making the asset available for use.

16. A computer-readable memory medium storing computer-executable process steps according to claim 13, wherein the enhancing step includes:
assigning a non-monetary value to the asset;
defining a need for the asset;
defining a method to determine if the asset meets the need;
determining a media to use to produce the asset based on the need;
confirming ownership of the asset;
creating a product from the asset.

17. A computer-readable memory medium storing computer-executable process steps according to claim 13, wherein the managing step includes:
enforcing the rights obtained in the asset; and
assessing value to the asset.

18. A computer-readable memory medium storing computer-executable process steps according to claim 13, wherein data acquired by the steps of claim 13 is aggregated into a single metadata file associated with the asset.
